(19) United States
(12) Patent Application Publication
(10) Pub. No.: US 2019/0285519 A1
(43) Pub. Date: Sep. 19, 2019

(54) METHOD FOR TESTING AT LEAST ONE DISINFECTANT

(71) Applicants: Ronald Brandes, Schortens (DE); Joachim Willms, Oldenburg (DE)

(72) Inventors: Ronald Brandes, Schortens (DE); Joachim Willms, Oldenburg (DE)

(21) Appl. No.: 15/922,617

(22) Filed: Mar. 15, 2018

(51) Int. Cl. G01N 1/38; G01N 9/36; G01N 21/75; G01N 27/416

(52) U.S. Cl. CPC G01N 1/38; G01N 9/36; G01N 2001/386; G01N 27/4167; G01N 21/75

(57) ABSTRACT

In a method for checking at least one disinfectant for its disinfection function, at least one sample of the disinfectant is mixed with a suitable inhibitor for this disinfectant and the reaction of the inhibitor is then measured in the sample with a sensor.

### BACKGROUND OF THE INVENTION

### Field of the Invention

The invention relates to a method for checking at least one disinfectant on its disinfection function.

### Brief Discussion of the Related Art

Disinfectants are used to kill germs in a variety of environments. Regular use is given in hospitals, children's homes or old people's homes where more pathogens can occur. Disinfectants are kept, for example, in containers from which disinfectants for spraying the hands, for spraying cloths or the like can be removed.

The problem is that in such hospitals and homes it often comes to pressure situations in terms of large numbers of patients or residents, low staff, a large number of interns or community service providers. All this can lead to a disinfectant being contained in a specific container for weeks or even months without paying any attention to its expiry date. Such a disinfectant may lose its disinfecting function, but it may even be contaminated with germs. Then a disinfectant would form a germination source.

### SUMMARY OF THE INVENTION

The object of the invention is to provide a method of the type mentioned, whereby a disinfectant is reliably verifiable to its disinfection function.

### DETAILED DESCRIPTION OF THE PREFERRED EMBODIMENTS

This object is achieved according to the invention in that at least one sample of the disinfectant is mixed with an inhibitor suitable for this disinfectant and the reaction of the inhibitor is then measured in the sample with a sensor.

The method according to the invention proposes an active examination of disinfectants during their use in, for example, hospitals. After the process, at least one sample is taken from the disinfectant, alternatively, the method can be performed directly in the actual existing disinfectant supply. The recovered sample or disinfectant is mixed with an inhibitor suitable for this disinfectant. An inhibitor is an antidote to a drug contained in the disinfectant, with which a sufficient concentration of this drug in the disinfectant is verifiable. In this case, an inhibitor is used for a particular disinfectant, which reacts to the active ingredients contained in the disinfectant and the disinfecting effect. The inhibitor thus makes it possible to check the sufficient concentration of the substances responsible for the disinfection function.

The checking is then carried out according to the method by a sensor which detects the measurement result in an automated manner. The measurement result is supplied via suitable interfaces or transmission paths to an evaluation. The sensor measures the reaction of the inhibitor after its contact with the disinfectant. If the disinfectant still has a high disinfecting effectiveness, it leads to a stronger reaction of the inhibitor, which is measurable. If, on the other hand, the disinfectant property of the disinfectant is bound by a higher concentration of bacteria in the disinfectant, the reaction on the inhibitor is lower, which in turn is determined by the sensor.

By the contact of the disinfectant with an inhibitor, for example, the conductivity of the disinfectant is changed. This change can be detected with a conductivity sensor. Alternatively, the sensor may also be designed as a light sensor, namely, if the reaction of disinfectant and inhibitor leads to a change in the turbidity.

Further alternatively, the sensor may be formed as a pH value meter or as a density sensor.

As an inhibitor, for example, a TSHC or TSLHTh called inhibitor manufactured by Bode can be used. It contains components such as Tween 80, saponin, histidine and cysteine. Such an inhibitor can be used for disinfectants with the names Manusept basic or soft or Sterillium with the additional names Comfort Gel, Gel, Gel pure, med, Rub Fragrance Free and Virugard.

Also, products of the company Schülke & Mayr GmbH, Norderstedt, Germany, can be used as inhibitors. For example, products named mikrocount® duo, mikrocount® TPC, mikrocount® TPC/E. These products are media for determining bacterial counts, but they can also be used as inhibitors of the effectiveness of a disinfectant by the method according to the invention.

1. A method for checking at least one disinfectant for its disinfection function, wherein at least one sample of the disinfectant is mixed with a suitable inhibitor for this disinfectant and the reaction of the inhibitor is then measured in the sample with a sensor.

2. The method according to claim 1, wherein a conductivity sensor is used as said sensor.

3. The method according to claim 1, wherein a light sensor is used as said sensor.

4. The method according to claim 1, wherein a pH-value meter is used as said sensor.

5. The method according to claim 1, wherein a density sensor is used as saki sensor.

6. The method according to claim 1, wherein sodium thiosulfate, lecithin, histidine, Tween 80, saponin and/or ether sulfate is used as inhibitor.
